(19) United States
(12) Patent Application Publication
(10) Pub. No.: US 2015/0081158 A1
(43) Pub. Date: Mar. 19, 2015

(54) METHOD OF DETECTING A DEFECT IN A STRUCTURE, DETECTOR DEVICE AND FLYING OBJECT

(71) Applicant: Airbus Defence and Space GmbH, Ottobrunn (DE)

(72) Inventor: Stephan Stilkerich, Ottobrunn (DE)

(21) Appl. No.: 14/487,239

(22) Filed: Sep. 16, 2014

(30) Foreign Application Priority Data
Sep. 16, 2013 (DE) 10 2013 110 151.8

(51) Int. Cl. B64F 5/00; G01M 17/00

(52) U.S. Cl. CPC B64F 5/0045; G01M 17/00; B64F 5/0009
USPC 701/29.1

(57) ABSTRACT

A method for detecting an error in an assembly, in particular, an assembly of a flying object, with the assembly being defined by at least one parameter. The method comprises detecting of several values of the parameter at several points of time and/or on several measuring points, grouping the values of the parameter in several groups, determining of the number of values in a group and triggering an error signal if the number of values in at least one group is not congruent with a predetermined range of numbers. Also, a detector device for detecting an error in an assembly, as well as a flying object provided with an assembly and such a detector device, can perform operations similar to the method.

### CROSS-REFERENCE TO RELATED APPLICATION

This application claims priority under 35 U.S.C. §119(a) to German Patent Application No. 10 2013 110 151.8, filed on Sep. 16, 2013, the entire contents of German Patent Application No. 10 2013 110 151.8 are hereby incorporated herein by reference.

### BACKGROUND

1. Field of the Invention

The present invention relates to a method for detecting and particularly handling an error in an assembly the assembly being characterizable by at least one parameter. The assembly is preferably disposed in a technological system which further preferable controls itself automatically and/or is unmanned. In particular, the assembly is provided in a flying object. Moreover, the invention relates to a detector device for detecting and particularly handling an error in an assembly. Furthermore, the invention relates to a flying object that includes an assembly and such a detector device.

2. Background Information

Flying objects such as aircraft, unmanned flying objects, helicopters or satellites, display a high degree of complexity in their design. As a result, it is often only difficult to recognize all kinds of errors and/or to initiate countermeasures. This applies to errors, in particular, which were not detected or cannot be detected in the course of the development or in routine tests of the flying object. The errors may be of a transitional or also permanent nature. In particular, such errors may also build up slowly throughout a certain time period so that their detection is particularly difficult. It is specifically in automatically controlled flying objects or also in flying objects that are out of reach, such as satellites, that the automatic detection and handling of errors is particularly helpful. This is often also termed “self-perception” (detecting) or “self-expression” (handling).

Therefore, it is an object of the present invention to provide a system which is capable of independently and reliably detecting errors and is in particular also capable of responding with suitable measures. This object can be achieved by the embodiments described herein.

The method for detecting an error in an assembly, particularly an assembly in a flying object, according to the invention comprises the following steps, the assembly being characterizable by at least one parameter. In a step, several values of the parameter are detected at several points of time and/or at several measuring points. A further step is the grouping of the values of the parameter in several groups and the determination of the number of values in a group. Moreover, the method is characterized by the step of triggering an error signal and/or measures if the number of values in at least one group is not congruent with a predetermined range of numbers and/or quantity.

An error in the meaning of the invention presented in the description is any deviation from a regular or desired operation of the assembly. Also a behavior of the assembly may be considered to be an error, which is contrary to the desired behavior of the assembly, without such undesirable behavior being considered to constitute an error or error from the very beginning. Errors of the assembly may give rise to an error condition, a breakdown or a reduced performance of the assembly.

The assembly may be provided in a technological system that operates preferably automatically and/or moves in an unmanned mode. The assembly may be used, for instance, in a submarine or on technological installations such as offshore platforms, which are difficult to reach. In particular, the assembly is applied in flying objects.

A flying object in the meaning of the present invention is any technological system capable of flying. In particular, this term should be understood to denote aircraft, helicopters, drones or other unmanned flying objects. Moreover, satellites or other orbiting objects are meant to be covered by the term “flying object”. In particular, the assembly may be a control system in aviation and aerospace, preferably with the ability to monitor the system's functions/threads critical in terms of safety (e.g. flight control, position and attitude control, navigation, cabin pressure, . . . ).

The assembly of a flying object may be understood to denote a component, a group of components, and a controller of one or several components or a system of the flying object. The assembly may, however, also include the flying object in its entirety. The condition of the assembly can be characterized by means of the parameter. The current flowing in the assembly, the voltage applied in the assembly or the temperature prevailing at different points in the assembly may be enumerated here as an example. By measurement of the temperature at different points on the flying object it is possible, for instance, to determine whether the system—in this case an air-conditioning system—operates properly. Furthermore, it is also possible, for instance, to measure the temperature in order to characterize the functional operability of an engine or propulsion unit, with the assembly being realized in this case in the form of the engine. Moreover, it is possible, for example, to measure the temperature on and/or in electronic components for characterization of the functional capabilities of avionics systems, with the assembly being present here in the form of the avionics system.

The method may preferably also be applied to use several parameters for characterization of the component. The individual parameters and their values may be combined in a single overall parameter.

In a step, the values of the parameters are detected. In the case of the aforementioned example of temperature as the parameter, here the temperature would be measured. This takes place particularly at different points of time, i.e. throughout a certain period, or at several different measuring points, which means at different locations on the flying object. In this context, “several” is to be understood to denote at least two, with many values of the parameter being determined in particular.

In a further step, the values of the parameter are grouped in several groups. In this context, “several groups” may mean two or more groups, with the number of the groups Y being preferably smaller than the number of the detected values X. In particular, Y is substantially smaller than X. The grouping of the values is done particularly on the basis of the magnitude of each value.

After grouping of the values, the number of the individual values in a group is determined. Specifically when the number of the values X is higher than the number of the values Y a group includes several values.

The predetermined range of numbers may be determined in advance by measurements or by simulation. When a range of numbers is applied it is possible to consider also tolerances in the determination of an error.

The error signal may be any signal such as a warning lamp, a warning notice or a warning sound. However, the term “error signal” should also be understood to cover any response intended to handle or at least mitigate the detected error.

Several groups are preferably compared against a respective range of numbers, which has the advantage, that the error can be determined particularly well. By the selection of the width of the range of numbers it is possible to take the sensitivity in the detection of errors into consideration.

With the method according to the invention, the flying object is analyzed for technological errors. The discovery or non-discovery of an error, i.e. the triggering of the error signal, has the technological effect that an objective assessment of the functional operability of the assembly is possible, which is performed automatically and independently.

The method according to the invention will now be explained in an exemplary manner with reference to temperature as an example. Here, temperature serves as the parameter for monitoring an air-conditioning system of the flying object, for instance. To this end, the temperature is measured at different points on the flying object and at different points of time in flight. In descent and ascent of the flying object, during which large temperature changes occur in the environment of the flying object, it may happen that the temperature deviates from a predetermined temperature level at isolated points on the flying object. With a conventional temperature measurement on a single point only such variations are often detected as error condition. With the method according to the invention, the values measured at different points of time and on different sites are assigned to different groups. Each group may include a temperature range. This furnishes a temperature distribution (also termed “temperature statistic”) which is characteristic of the various flight phases, on the one hand, and also for the total period in flight of the flying object. To infer an error the number of the found values is compared to a range of numbers for one, several or all groups. This range may be determined, for example, on the basis of a measurement on an operable air-conditioning system. When the detected distribution deviates from the initially determined distribution this may be a hint to an error.

A further exemplary explanation of the inventive method will be given in the following with reference to temperature as an example. Here, the temperature serves as a parameter for monitoring the avionics bay and its functionalities of the flying object, for instance. To this end, the temperature is measured on different points of the avionics bay, on and/or in several electronic components and at different points of time in flight. It is specifically in different phases of the flight/mission of the flying object that the temperature is characteristic of a correctly operating avionics system or an avionics system possibly operating in a faulty condition. With the method according to the invention, the values measured at different points of time and on different points are grouped in different groups. Each group may include a temperature range. This furnishes a temperature distribution (also termed “temperature statistic”) which is characteristic, on the one hand, of the different flight phases and also of the total period in flight of the flying object. To infer an error, the number of the found values is compared against a range of numbers in one, several or all groups. This range may be determined, for instance, on the basis of a measurement on a fully operable avionics bay. When the detected distribution deviates from the initially determined distribution this may be a hint to an error.

The method according to the invention allows for a differentiation of errors both with respect to temporal and local aspects.

An advantage of the method resides in the aspect that it is robust. An individual or a small number of incorrect input values, such as a defective sensor for the detection of the temperature, does not completely destroy the report of the system so that no error is signaled when the system operates properly as a whole, despite isolated erroneous measurements.

Another advantage of the method is the aspect that the representation in terms of time may be adapted. To this end, the number of points of time (i.e. the period of time) at which values of the parameter are sampled may be varied for scrutinizing particular defined time periods for errors. The method allows, for instance, orienting the search for errors by defined flight phases by adaptation of the points of time at which the values of the parameter are detected.

Moreover, the groups may be adapted to an expected error. This means, that an individual group may be tailored in such a way, that it furnishes a particularly significant hint to an error if the number of the values varies from the predetermined range of numbers.

It is furthermore possible with the method according to the invention to preferably modify the selected criteria with respect to the group and the sampling of the values of the parameter even during the operation of the assembly so that the method may be applied to analyze the assembly for different errors.

The method is preferably solid in mathematical terms so that a mathematical representation of the error is possible, which allows further processing by means of statistical methods and tools.

It is furthermore preferred that the method may be executed by a data-processing system as the detected values of the parameters are edited by means of the method in such a way that they are machine-readable. The method preferably offers the opportunity to represent the results of the individual steps in such a manner that they can be easily transferred from one step to the other.

With the method, the values of several parameters are preferably detected. The detection of an error can hence become more reliable because the error signal having regard to one parameter can be compared with the result of another parameter. For example, a signal for an error is only triggered, when at least two error signals determined for two different parameters was triggered.

It is preferable that the parameter is a physical parameter that is preferably detected by way of measurement. It is further preferable that the parameter is an operating parameter of a controller of the assembly, with the operating parameter being detected by measurement of the controller.

The term “physical parameter” may be understood to cover any parameter that can be detected by a technological apparatus, for instance in the set-up of a measurement. The measurement may be of a technological nature.

The term “physical parameter” may also denote an external interference with the assembly. An example of external interference is the impingement of a high-energy particle on the assembly. This may happen with satellites or small semiconductor components. The sensor for such a measurement may be a distributed memory, for instance. To this end a pattern is stored in the memory which is preferably generated by hard-wired circuits. The pattern is provided with a check sum, in particular, which can be verified after a certain period of time. Variation may be assessed as impingement of a high-energy particle. This is one example of a measurement procedure. In this example, the grouping corresponds to the point where the particles impinge, for instance the particular region in the memory. The number of the impinging particles per region can then be compared against a range of numbers for conclusion of an error.

The term “controller” may be understood to cover all devices or components by means of which the assembly can be controlled. When the assembly is an air-conditioning system, for instance, the controller is that component of the air-conditioning system which controls the air-conditioning system. All those variables may be understood to be operating parameters, by means of which the operation of the controller can be characterized. The controller may be a data-processing system such a computer, a processor or the like, for instance.

A data-processing system may also be composed of several computer boards equipped with one or several CPUs (e.g. power PC processors), memories, FPGAs, interfaces and BUS systems. These sub-systems may be combined in major systems and represent, for instance, the overall avionics system of the flying object. For example, it is hence possible to detect the values of temperature and voltage or the tension at different system levels. It is possible, for instance, to determine the temperature and voltage values of individual sub-systems including several boards, and, on the other hand, in a highly locally focused manner for individual components (CPU, FPGA, . . . ). The more local the focus is in the detection of typical values (temperature, voltage, “thread” run time, “thread” memory) the more local and more precise the error location in the system can be.

It is preferred that the parameter includes a temperature value in and/or on the assembly and/or a speed, particularly of a propulsion unit of the flying object, and/or a voltage in and/or on the assembly.

The temperature can be measured on a propulsion unit or in the flying object. The speed may be the speed of rotation of the propulsion unit of the flying object. The term “assembly” may also be understood to denote the electrical supply system of the flying object so that the system can be characterized with reference to the voltage.

It is preferred that the operating parameter includes the duration of a process of the controller and/or the memory utilized by the controller and/or the data movement taking place in the controller.

The term “duration of a process” may be understood to denote the period of time which a process requires that is executed in the controller. An example of a process is a thread. When the duration of the process changes (which is also referred to as period of execution) by requiring less or more time than expected, this is an indication of an error. The detection of the duration of the process hence permits the conclusion of the correct operation of the controller.

When the controller is provided by a data-processing system the memory utilized by the controller may be an indication of the fact that the controller operates properly. On the one hand, this may be the working memory of the controller, and also the volume of the data stored by the controller in the memory.

The controller may be configured as a network, for instance. The data movements taking place therein may also be used as a parameter for the characterization of the controller and hence of the assembly. The data movements within a data-processing system may be employed as parameter for characterization, too.

It is preferred that a statistic is set up with the values detected, with the grouping criterion in a group of at least one group being preferably distinguished from the criterion of another group, and with the grouping criterion of at least one group being furthermore preferably determined by a range of values that is linked up with an error in the assembly.

When a plurality of values is detected, in particular, which is grouped into a plurality of groups, it is preferred that this is represented in the form of a statistic, with the number of values being preferably represented throughout the groups. This is a discrete probability distribution or statistic

When the individual groups are selected, i.e. the range within which the values of a parameter can be assigned to a group, the error to be expected can be taken into consideration. In the event of the temperature measurement described above, for instance, a temperature range indicating errors with a particular sensitivity may be used to define this fact as a separate group so that variations in this group will be especially considered in the assessment of whether an error has occurred. This may be realized, for example, by the provision that one group is subdivided into two sub-groups when all groups have the same width, e.g. a range of values of 5° C. These sub-groups may then include 2° C. and 3° C., for instance.

The predetermined range of numbers is preferably a predetermined statistic, the established statistic being preferably compared against the predetermined statistic.

The predetermined range of numbers may be a statistic, for instance, which has been established with an assembly free of errors. The two statistic records can then be preferably analyzed by means of statistical methods or tools. Here the Kullback-Leibler divergence, the CHI square test should be mentioned as examples. When the degree of this statistical comparison exceeds a certain value this may indicate an error. The predetermined range of numbers may also be understood as statistic in this meaning, with the degree of deviation determining a tolerance range.

Another aspect of the invention is the provision of a detector device for detecting an error in an assembly, in particular an assembly of a flying object, with the assembly being characterizable by at least one parameter. The detector device comprises a measuring device, an analyzer device and a warning device. The measuring device is suitable for the sampling of several values of the parameter of the assembly at different points of time and/or on several measuring points. The analyzer device groups the values of the parameter in several groups and determines the number of the values in a group. The warning means triggers an error signal if the number of the values in at least one group is not congruent with a predetermined range of numbers.

The considerations and advantages set out in the context of the method are valid also with respect to the detector device.

The detector device may be provided for an assembly in a technological system which operates preferably automatically and/or moves in an unmanned way. For instance, the assembly may be used in a submarine or on technological assemblies which are difficult to reach, such as off-shore platforms. In particular, the detector device is employed in flying objects.

The detector device is capable of determining the values of one or several parameters of the assembly by means of the technological measuring device. The analyzer device groups these values and determines the number of the values in a group. The warning device triggers the error signal so that the technological effect can be achieved to determine and particularly correct an error automatically and independently.

It is preferred that the parameter is a physical parameter that can be detected preferably by at least one sensor of the measuring device, and/or that the parameter is an operating parameter of a controller of the assembly, with the operating parameter being detectable by a monitoring device.

With a view to the physical parameter and the operating parameter applies what has been set out in the foregoing. The sensor determines the temperature preferably at different points of time. In particular, a plurality of sensors is provided in the assembly so as to permit a particularly good characterization of the assembly. The monitoring device may be implemented as three-dimensional physical device for sampling of the controller's operating parameter. As an alternative, the monitoring device may also be implemented as software for the sampling of the controller's operating parameter.

It is preferred that the sensor is suitable for measuring a temperature in and/or on the assembly and/or a speed, in particular of a propulsion unit of the flying object, and/or a voltage in and/or on the assembly. It is preferred that the measuring device is suitable for the sampling of the duration of a process of the controller and/or the data communication taking place in the controller. Here, too, the considerations apply which have been set out in the foregoing.

It is preferred that the analyzer device is suitable to establish a statistic from the values so detected, with one criterion for grouping of at least one group being preferably distinguished from the criterion of another group, and with the criterion for grouping of at least one group being furthermore determined by the range of values that is related to an error of the assembly. The analyzer device may be configured as an electrical circuit which increases a counter of one group by 1, depending on the magnitude of the parameter detected. According to an alternative, the analyzer device may also be implemented as software.

It is preferred that the predetermined range of numbers is a predetermined statistic, with the analyzer device preferably comparing the statistic so generated against the predetermined statistic. In particular, the analyzer device employs the aforementioned statistical methods.

Furthermore, the invention provides a flying object that comprises a assembly and a detector device for detecting an error in an assembly, as has been described in the foregoing. The flying object is an unmanned and/or automated technological system in particular. Alternatively, the flying object may be an aircraft such as an airplane or a helicopter.

### DESCRIPTION OF THE DRAWINGS

In the following, the invention will be characterized in more details with reference to embodiments. In the schematic representations in the drawings

FIG. 1 shows a flying object with an assembly in a first embodiment;

FIG. 2 shows a flying object with an assembly according to a second embodiment;

FIG. 3 is a block diagram schematically illustrating one embodiment of the method;

FIG. 4 illustrates sketches of discrete probability distributions;

FIGS. 5a, 5b show examples of different binnings with normalized data, with seven binning zones being used in FIG. 5a and six binning zones being used in FIG. 5b;

FIGS. 6a, 6b illustrate examples of different sampling sizes which are not normalized, with 100 measurements being used in FIGS. 6a and 10 measurements being used in FIG. 6b;

FIG. 7 shows an example of a homogeneous binning with a high sampling number, which illustrates a typical profile of a region of high activity (high temperature) followed by a low activity (low temperature) and cooling and restart;

FIG. 8 illustrates an example of an assembly for detecting errorive isolated events, with the points indicating memory components/regions with a predetermined pattern and a correction code for the identification of errors, with the definition of the regions corresponding to the groups in the distribution;

FIG. 9 shows an example of a distribution of error measurement of individual events, wherein the activity occurs in regions 1, 3, and 4 but not in region 5 which is reliably identified as individual event error;

FIG. 10 shows the distribution of execution times of a simple control algorithm for a satellite application;

FIG. 11 shows an example of the distribution of a flat execution, illustrating three modes of execution periods which are typical of three execution paths in the thread (e.g. case statements); and

FIG. 12 is a graphical schematic view of a scenario.

### DETAILED DESCRIPTION OF EMBODIMENTS

The method serves to monitor an assembly 14 that is provided in a complex technological system. The method is applied to check the assembly 14 for errors. This is performed automatically. The monitoring method is implemented by means of a sampling device 16. The complex technological system is a flying object 10 in this embodiment.

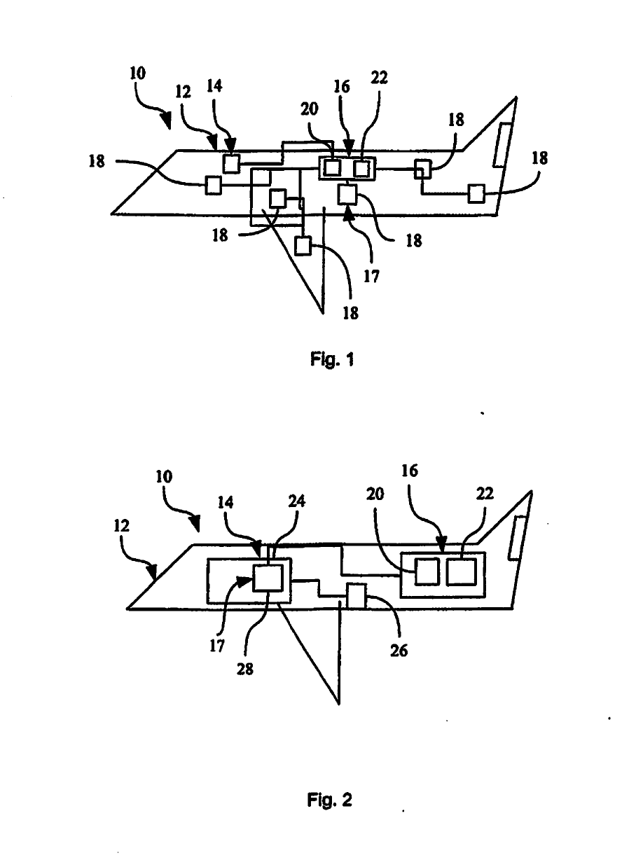

FIG. 1 shows the flying object 10 as an airplane 12. The airplane 12 includes the assembly 14, which is an air-conditioning system in the illustrated example. The air-conditioning system controls the temperature in the airplane 12. Moreover, the detector device 16 is provided in the airplane 12. The measuring device 17 is provided by a plurality of sensors 18 which take the temperature in the airplane 12 at different points and at different points of time. The parameter is here the temperature and the value of the parameter is the actually measured temperature.

The detector device 16 is furthermore provided with an analyzer means 20 and a warning device 22. The analyzer device 20 processes the temperature values and furnishes the result to the warning device 22. When an error or trouble condition has occurred the warning device issues an error signal and/or corrects the error.

In FIG. 2 the assembly 14 includes a controller 24. The controller 24 controls a component 26 of the airplane 12. A monitoring device 28 is disposed in the controller 24, which detects parameters of the controller 24.

The measuring device 17 is provided by the monitoring device 28, as is illustrated in FIG. 2. The monitoring device 28 is connected to the analyzer device 20 and the warning device 26.

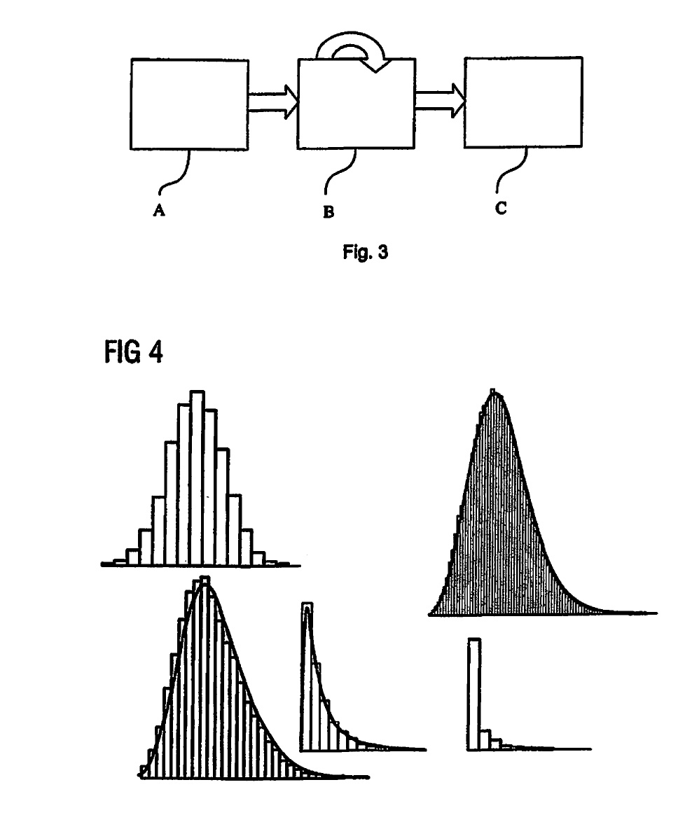

The block diagram illustrated in FIG. 3 is a schematic illustration of the flow of the monitoring method that is realized by means of the detector device 16. In stage A, the values of the parameter or parameters are detected, grouped and the numbers of the values in the individual groups are determined. This results in discrete probability distributions of the parameter or parameters. In stage B, which is also referred to as self-perception step, then the number of the values in at least one group is compared against a range of numbers and/or statistical comparative measure are determined. The results of this evaluation are stored in a feature vector. Additionally a time component is incorporated into the system via a loop. In stage C, which is also referred to as self-expression step, the feature vector is then evaluated. If values of the feature vector are beyond a defined range an error signal is triggered and/or the error is processed.

The method will be described in details in the following with reference to the stages shown in FIG. 3.

System features of self-perception and self-expression is utilized for proposing alternatives for error tolerances, so as to cope with the conventional error tolerance concepts for further processing assemblies as well as for communication/network assemblies, which are intensive in terms of resources. In detail, an approach is adopted which provides for the processing of interlinked error tolerances at the thread level and communication-/network-related error tolerances by way of providing alternative routing paths through the network; all decisions and effects are derived from the self-perception and the self-expression.

A three-stage model, which is schematically illustrated in FIG. 3, is proposed for the implementation of the features of self-perception and self-expression—the capability of the system or the assembly 14 to know its own status, its entities, capacities and connections to other units/knots, just to name only a few specific abilities, and to trigger (counter) responses autonomously—in technological computation systems.

In stage A, different physical system parameters or any kind of system statistic records are sampled and pre-processed. Additionally, a common representation (discrete distribution of probabilities) is used with specific features. Further details about the common representation by means of discrete probability functions will be specified in the following.

In stage B, a feature vector is generated on the basis of the data sampled and pre-processed in stage A. Additionally, the information of the feature vector as such may be used for processing in stage B. This entails the opportunity to build up a memory in this step via the features of the system.

Finally, appropriate system (counter) actions and modification scenarios are computed in stage C, and eventually realized for correction of the error.

### Three-Stage Model

As has been described in the foregoing, a three-stage model is proposed for converting the self-perception and the self-expression in technological systems into practice. The identification of suitable system features and system statistic records as well as the processing and the robust presentation of these parameters (stage A) constitute one configuration decision for creating the self-perception (stage B). It was decided to represent the system features and the system statistic records by discrete probability distributions and probability measures as well as statistical tools in order to generate the robust feature vectors representing the system's self-perception. The configuration of the probability distributions takes place n stage A whereas the computation and the creation of the feature vectors take place in stage B as the central activity for constituting the self-perception of the system. Additionally, a-priority knowledge of the system and of the environment are used in stage A as some kind of fundamental and general experience of the system in order to control and restrict the creation of the self-awareness. Finally, the self-expression and consequently the appropriate actions, signals and modification strategies are computed in stage C for handling arising, temporary or permanent errors.

### Stage A

First of all, features of the system are identified which are relevant for the concrete system and the application scenario; and then the appropriate data is sampled. On principle, one can distinguish the following three categories of system features from each other:
1. Physical parameters of the system, which are measured by various sensors, such as temperature, voltage, speed of the propulsion unit, network-related features, etc.
2. Statistic records of the system, which are sampled and computed during operation, including information about the threads, processes, the processing period, the memory utilization, the network traffic, etc.
3. Predetermined parameters of the system and operating conditions provided a-priori, which set up thus a-priori knowledge.

### Representation of Information

A critical configuration decision about the configuration is the representation of all the system information sampled, as has been described above and which may derive from different sensors with different characteristics, run-time statistic records of the various systems and even a-priori knowledge of the system as such or its environment.

Therefore a mathematical representation is required which offers the following elementary features simultaneously:
1. Robustness—a single or a small number of incorrect data entries should not completely destroy the representation.
2. Adaptability of the representation and varying resolution.
   (a) With a view to time—different periods for data sampling and therefore the quantity of data incorporated into the representation.
   (b) Details—mapping von ranges of values related to discrete values (binning), including non-homogeneous ranges of values; these are also referred to as groups.
   (c) throughout the sequence of operations—modification of the aforementioned features during the sequence of operations.
3. Mathematically well-founded.
   (a) systematic mathematically well-founded representation.
   (b) tool set for the further processing and analysis (stage B and stage C).
4. It must be possible to process the representation efficiently by means of digital computers.
5. Interfaces, well-defined interfaces between stage B and stage C.

Discrete probability distributions such as those shown in FIG. 4 in an exemplary form are suitable and have therefore been chosen for this approach so as to represent all the data sampled for the self-perception step and the subsequent self-expression step in a flexible, robust and systematic manner. A single datum is obviously a special case and is not precluded from this discussion.

### Exemplary System Features

In the first category—physical parameters of the system, measured by various sensors—the following features are mentioned as an example of a physical parameter:

1. Temperature measurements: This feature serves as a strong indicator of the overall system status and signals overload conditions or cooling—problems with different scales in space (sub-system, module and component), time (sampling number) and resolution (grouping or binning zones). Specific temperature situations may gradually develop into an abnormal system condition or may hint to an abnormal system condition with a troubled system function.

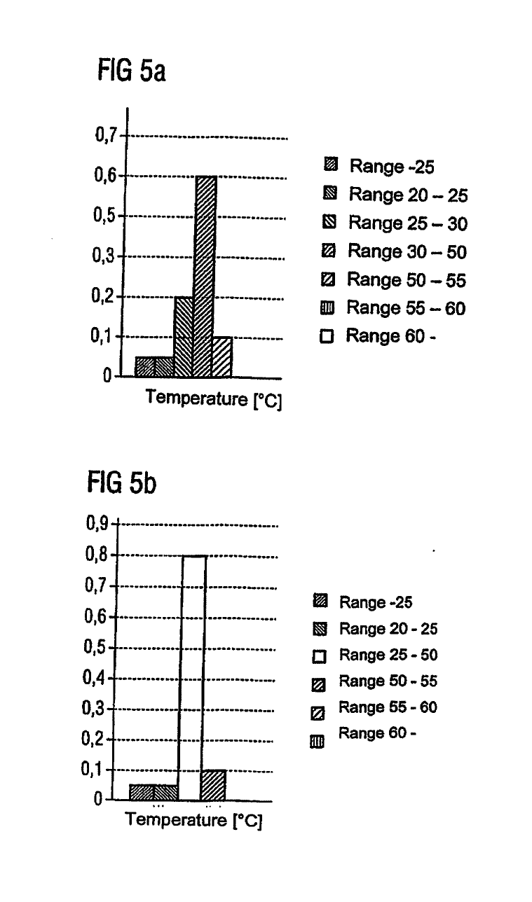

FIGS. 5a and 5b illustrate examples of discrete probability distributions with different numbers of bins (or groups) covering the range of potential values. FIGS. 5a and 5b (left side) are provided with two bins, one for temperature values from 25° C. to 30° C., and one for the temperature values from 30° C. to 50° C. In FIGS. 5a and 5b (right side), the temperature range from 25° C. to 50° C. is combined in a single bin and therefore this peak in distribution gains dominance whilst the marginal areas are disappearing.

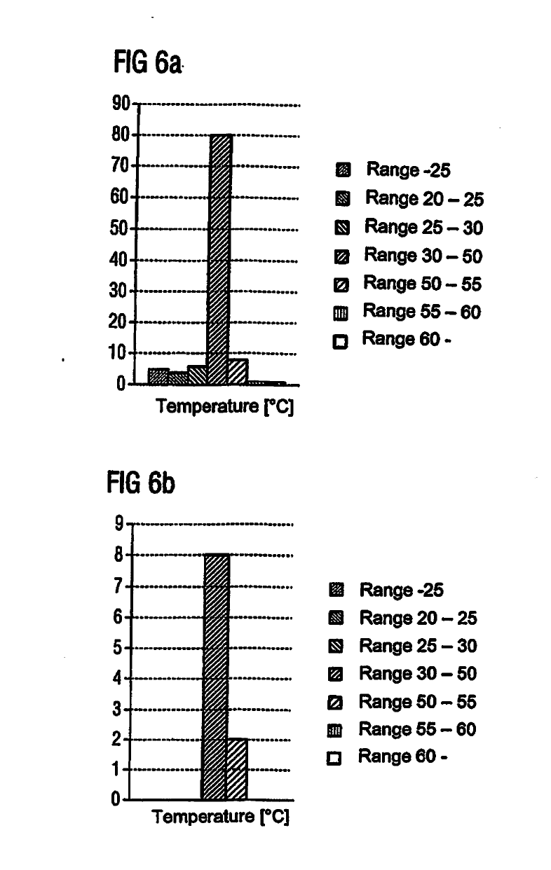

FIGS. 6a and 6b illustrate examples of different sample sizes for setting u the distribution. A major sample size normally covers a major period of time in which the data is sampled, if the sample rate is presumed to equal the signal. Consequently, a smaller sample size represents a normal snapshot of the instantaneous situation whereas a greater sample size reflects a longer period of time.

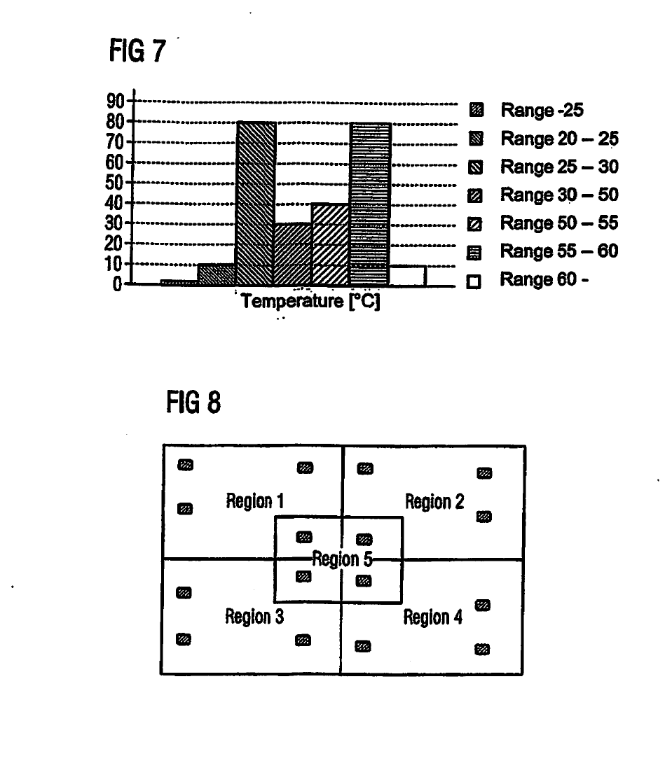

FIG. 7 (left side) shows a typical example of a probability distribution with a voluminous sample set and therefore with a long period of time, which signals probably an activity in the subsystem reflected in the temperature around 55° C. to 60° C., and an uncovered temperature between 25° C. and 30° C. This could be used as typical profile and any kind of divergence from this profile is a sign of a potential malfunction.

In conclusion, the representation of temperature by means of discrete probability distributions permits the coverage of a wide spectrum of different system temperature characteristics for the identification of errors and errors and for the conclusion of arising system malfunctions. It is possible to monitor temperature profiles of components, major sub-systems or a complete system. Different sampling volumes permit the monitoring of temperature profiles throughout different intervals and it is therefore possible to investigate rapidly and slowly varying temperature profiles in a systematic approach. Additionally, a typical temperature profile may be taught throughout a major period of time. The binning facility permits the modification of the resolutions in the distribution and the modeling of regions of particular interest with a higher resolution.

The temperature self-perception feature permits the identification of short-time as well as long-time characteristics for the recognition of error and error tolerance mechanisms at the level of the operating sequence.

2. Individual measurements of erroneous events: For the systematic identification of errors induced by high-energy particles—which is specifically relevant for satellite applications and which becomes equally more and more relevant for systems and components with today's semiconductor component dimensions—an indirect method is proposed which operates on an unlinked network of distributed memories. Various memory components (DRAM that may be sensitive to errors in isolated events) or memory regions inside an FPGA (abbreviation of application-programmable logic) are stored with a specific storage pattern and protected by a simple error correction code for the detection of errors. The memories are repeated checked in order to detect errors in the storage pattern. Die stored storage patterns display the characteristic that they can be generated by fixedly wired circuits without storage elements. The storage pattern is stored in the memory and provided with a check sum. When the fact has been detected after a certain execution period that the check sum is no longer correct the occurrence of one or several individual error events is concluded. Then the pattern is generated again by means of the fixedly wired circuit. The unit for the generation of the pattern consists only of a single fixedly wired circuit so that the unit as such will not be susceptible to individual error events.

Then an event is concluded from certain errors. In order to render the identification robust and helpful for the self-expression step (possible modification of the system, the operating sequences, etc.) a prudent design of the discrete distribution of probabilities and of the sampling strategy eliminates incidental events which trigger an error.

Cautious organization and assembly of the memory components/regions permits the identification of defective regions or safe regions for processing with respect to individual error events. This kind of information is helpful for the self-expression step and the re-organization of the sequences.

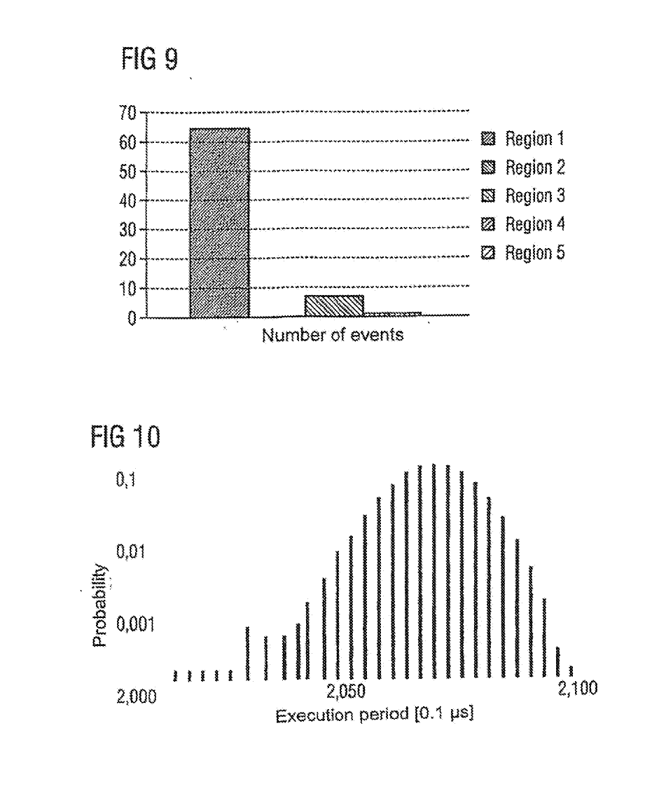

FIG. 8 illustrates an assembly representing the embodiment, wherein the points represent memory components or regions with stored patterns. The defined regions correspond to the grouping or bins of the distribution, which are illustrated in FIG. 9. Depending on the manner in which the regions are grouped a different distribution is achieved.

3. Voltage measurements: measuring and monitoring of characteristic voltage curves in the system.

4. Speed of a propulsion unit: is related to the temperature and may be used for verification of the temperature measurement and vice versa.

In the second category—system statistic records generated during the operating sequence—the following features will be discussed as examples of the operating parameter:

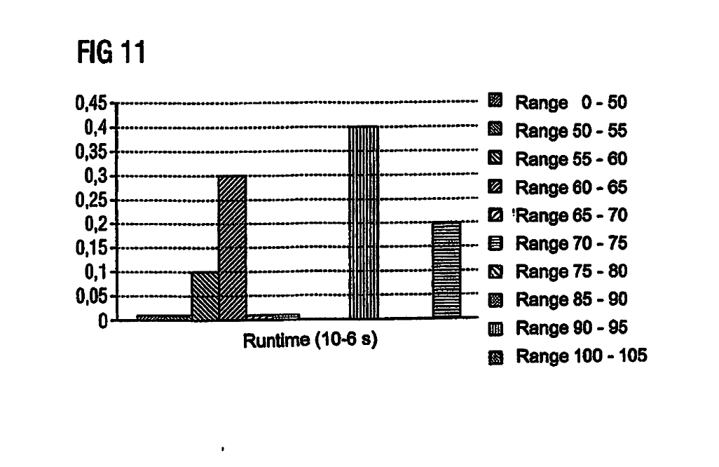

1. Thread runtime measurements: The period of execution of a thread n a specific platform may be determined in advance by a lower limit (best execution time) and an upper limit (worst execution time) and the probabilities of the execution times between these two limits. In this context, the term “thread” abides by the standard definition of a software thread in information science. The lower and the upper limits may be determined analytically and with certainty. Values between these two extreme cases may be determined by simulation sequences or during the runtime. FIG. 10 illustrates an example of such a simulation sequence, showing a distribution of runtimes for a control algorithm of a satellite.

In a first approach, the information of extreme cases is used and the execution period over the entire period of time is sampled in order to create a distribution. Any outliers beyond the region between the lower and the upper limit are discarded during this process and constitute an error of the thread.

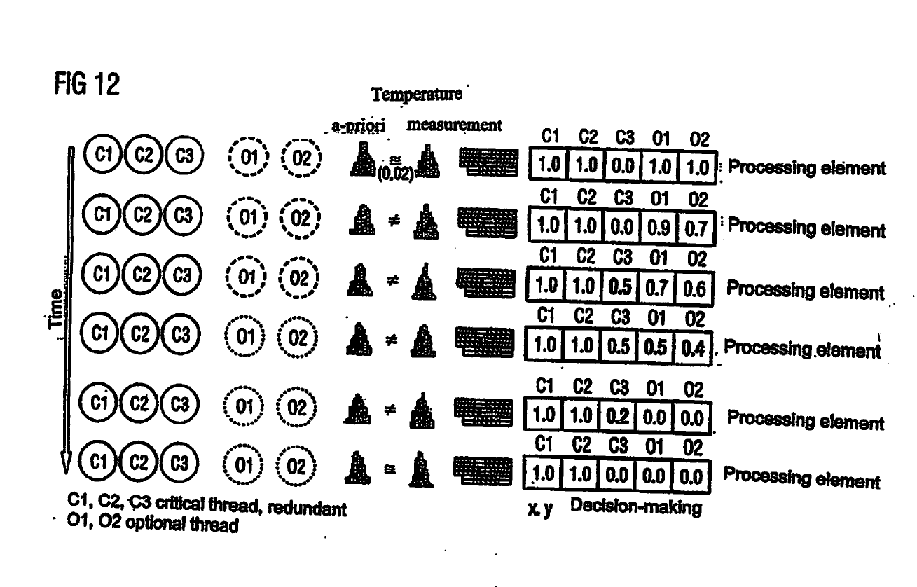

A distribution of execution periods can be established systematically with reference to the thread even without the use of the lower and upper limit values. This process of thread execution measurement may result in distributions of the kind shown in FIG. 11, which illustrates three mode distributions typical of the operating sequences with three program branches and substantial differences in the computation in each branch. The individual peaks in the distribution correspond to one mode of the thread execution period.

2. Thread stack utilization measurements: A lower and an upper limit can be analytically determined for the stack utilization of a thread. These two limits may be employed again to identify outliers during the sampling of the stack utilization data throughout the operating sequence in order to set up the probability distribution characterizing a typical thread. The stack utilization of a thread may present this kind of distribution in a way similar to FIG. 11. The characteristic distribution may be observed with one or several modes, in dependence on the thread.

3. Thread memory utilization measurements: A typical distribution can likewise be established for the specific memory utilization of the thread. A detailed analysis of a worst-case value of the memory utilization of the thread can be provided in advance. Moreover, the execution period and the stack utilization as well as probability distributions with one or more modes may equally be characteristic, in dependence on the computations and the memory utilization of the thread.

4. Memory profile: A characteristic probability distribution corresponding to a regular or a typical sub-system status can be established even for the complete memory system. Using an analytical analysis, it is sometimes possible to determine the worst-case memory utilization as the upper limit.

5. Network activity profile: Several suitable features of the network assembly may be employed. In this case, the focus is on a multi-stage interconnection network (MIN) which may be blocking or non-blocking and which may be implemented as direct connection or on the basis of packages.

In the third category—a-priori system and knowledge of the environment —discrete probability distributions may be provided for all the aforementioned features at specific process steps or on the whole, which reflect a typical or a regular status of the system at a particular point of time. A flexible and extensive representation tool can be created by means of the selected representation (discrete probability functions).

### Stage B

The different discrete probability distributions, which were created by different sensor signals or system statistic records in stage A, reflect already a broad focused status and a computer-directable version of a system self-perception. Further processing and focusing of this information, heading for a feature vector, constitutes an essential step for the generation of input data (feature vector) for step C in which the self-expression takes place which converts eventually the error tolerance method into practice. This further processing and focusing takes place in stage B. As a function of the algorithm in stage C and the further processing/focusing steps in stage B, the feature vector/feature vectors may have different lengths, assemblies and meanings.

Further processing of information/focusing approaches

On account of the representation of the system information by means of discrete probability distributions, which entail the above-described advantages, it is possible to apply different statistical tools, methods and measures for the further processing of the distributions and for the generation of the values for the feature vector (the feature vectors).

The proposed approaches will be described in the following:

The Kullback-Leibler divergence measure (relative entropy)

The comparison of a-priori knowledge about certain system features (which is represented by a predefined and given discrete probability distribution) which define the normal or regular state of the system feature with the measured feature data and the discrete probability distributions set up in stage A, constitutes an efficient approach for recognizing variations of this system feature from the regular status and behavior so as to conclude thus irregular system conditions and behavior, which cumulate eventually in an error.

The Kullback-Leibler divergence is a measure for the mathematically sound performance of comparisons of probability distributions.

The Kullback-Leibler divergence (relative entropy) is defined for discrete values of the probability functions P and Q as follows:

$$D ( P \vert \vert Q ) = KL ( P , Q ) = {\sum }_{x ∈ X} P ( x ) \cdot log \frac{P ( x )}{Q ( x )}$$

For the sake of completeness, the integral is used for continuous values represented by a density function:

$$D ( P \vert \vert Q ) = {\int }_{- ∞}^{∞} p ( x ) \cdot log \frac{p ( x )}{q ( x )} d x$$

The Kullback-Leibler divergence (KL) has some properties of a metric, and as it possesses only a few metric properties it is referred to as KL divergence rather than KL metric in the space of the probability function. In detail, it is non-negative, which means KL (P, Q)≧0, with equality if Q=P, but it is not symmetrical and does not satisfy the triangle inequation.

Even though the KL divergence is not a metric it is sufficiently powerful as a comparison measure for providing useful information in the space of the probability functions, and therefore as a statistical model (a-priori or established throughout the execution period) for the purpose of creating robust self-perception system features.

The KL divergence is obviously only one among several statistical measures and tools for evaluation of discrete probability functions and for providing robust information in order to set up feature vectors systematically which represent system self-perception.

### CHI Quadratic Test

### Anderson-Darling/Kolmogorov-Smirnov

Mutual information (non-linear dependence=0, two variables are strictly independent and not only uncorrelated. Self-information feature. Indication of an error.)

### Stage C

In stage C, a graphic model is used which represents the components and/or sub-systems and their corresponding representation and system utilization. The edges of the graphs represent plain 0-1 probabilities. Certain actions may takes place at certain probabilities or during probabilities derived during the runtime.

The respective rules may be defined by mathematical terms and linked for the subsequent final result.

In the following, one embodiment will be presented again as an alternative.

Idea (1)
Self-perception is not a plain representation of a “value”; it subsists rather on a-priori knowledge (and learning).
   Self-expression is not always deterministic (graphical models, probabilities)
   and is robust as such with respect to errors.
It is set up by statistic records and statistical processes.

Idea (2)
1. Sampling of information
2. Examining, comparing probability distributions (measured against a-priori knowledge)
3. Graphical models (threads, network, architecture, mapping, components, systems)
   tool for directing decisions
   decision and event.

Representation—Discrete Probability Distributions

Robustness

Adaptability of the representation and varying resolution
with a view to time—different periods for data sampling and therefore for the volume of data incorporated into the representation
in detail—mapping of the ranges of values to discrete values (binning), inclusive of non-homogeneous ranges of values
during the runtime—modification of the aforementioned features during the runtime

Mathematically sound
representation systematically on a mathematical basis
tool suitable for further processing and analysis

Suitable for efficient processing by means of a computer

Well-defined interfaces

### Self-Perception

First category—physical system values measured by various sensors
temperature measurements
speeds of the propulsive unit, voltage measurements

Second category—systematic statistics set up throughout the runtime
thread runtime measurements
measurements of thread stack utilization
measurements of thread memory utilization
memory profiles
network status/activity profile

Third category
a-determined off-line
learning on-line

### Scenario (1)

System Setting
one knot with three different threads
   one thread “critical”, double redundancy and comparison
   two threads “optional”
features: two times temperature, thread execution period, a-priori knowledge
probability distribution measure against a-priori knowledge
examination against a-priori knowledge

Self-Perception
feature vectors
   temperature, two values of the probability distribution measure
   execution period, four values of the probability distribution measure
   result of the comparison, counter-measures to correct errors

### Scenario (2)

Regular Operation
values of the temperature distribution probability, execution period examination, comparison OK
   no automatic triggering event and TLFD (thread level error tolerance)

Temperature Operation
examinations of execution period, comparison OK, values of temperature probability distribution arousing suspicion
   automatic triggering and TLFT→suspension of optional treads in order to secure critical thread

Comparison of the Erroneous Operation
examinations of the execution periods, comparison failed, temperature probability distribution OK
   automatic triggering and TLFT
      1) provision of the old value, 2) preparation of a third version of the thread
      1) provision of the second value, 2) start of the third thread, 3) suspension of the optional threads

### Scenario (3)

Threads Crash/Lock Up/Display Undesired Behavior
temperature probability distribution values, execution period examinations failed, comparison failed
   automatic-triggering event and TLFT→deleted thread and restart

FIG. 12 is a schematic view of Scenario (4). The temperature operation is monitored by means of three critical threads C1, C2 and C3 and three optional threads O1 and O2. The distributions of the individual threads are compared against a-priori distributions. The variations of the individual threads are represented on the right side. Based on the variation so determined, the decision can be automatically taken to suspend the optional threads in order to secure the critical threads.

Temperature Operation
examination of the execution period, comparison OK, temperature probably distribution values arouse suspicion
   self-expression and TLFT→suspend optional threads n order to secure the critical thread

### Self-Perception

Physical values of the system measured by various sensors, including temperature, voltage, operating speed, network-related features, etc., for instance
Statistical records of the system, which are sampled and computed throughout the runtime, including information about the thread, processing period, memory utilization, network communication, etc.
Predetermined parameters of the system and the operational environment; a-priori knowledge

What is claimed is:

1. A method for detecting an error in an assembly of a flying object, the assembly being defined by at least one parameter, and the method comprising:
detecting several values of the parameter at at least one of the following: different points of time and different measuring points;
grouping the values of the parameter in several groups;
determining the number of values in a group; and
triggering an error signal if the number of values of at least one group is not congruent with a predetermined range of numbers.

2. The method according to claim 1, wherein the parameter is at least one of the following
a physical parameter that is detected by a measurement; and
an operating parameter of a controller of the assembly, the operating parameter being detected by measurement of the controller.

3. The method according to claim 2, wherein the parameter comprises at least one of the following
a temperature in the assembly;
a temperature on the assembly;
a speed of a propulsion unit of the flying object;
a voltage in the assembly; and
a voltage on the assembly.

4. The method according to claim 2, wherein the operating parameter comprises at least one of the following
a duration of a process of the controller;
a duration of memories utilized by the controller; and
data communication taking place in the controller.

5. The method according to claim 3, wherein the operating parameter comprises at least one of the following
a duration of a process of the controller;
a duration of memories utilized by the controller; and
data communication taking place in the controller.

6. The method according to claim 1, wherein
the detected values are used to generate a statistic, the criterion for grouping of at least one group being different from the criterion of another group by a range of values related to an error of the assembly.

7. The method according to claim 6, wherein
the predetermined range of numbers is a predetermined statistic, with a statistic being compared against the predetermined statistic.

8. The method according to claim 2, wherein
the detected values are used to generate a statistic, the criterion for grouping of at least one group being different from the criterion of another group by a range of values related to an error of the assembly.

9. The method according to claim 3, wherein
the detected values are used to generate a statistic, the criterion for grouping of at least one group being different from the criterion of another group by a range of values related to an error of the assembly.

10. The method according to claim 4, wherein
the detected values are used to generate a statistic, the criterion for grouping of at least one group being different from the criterion of another group by a range of values related to an error of the assembly.

11. A detector device for detecting an error in an assembly of a flying object, the assembly being defined by at least one parameter, and the detector device comprising
a measuring device configured to detect several values of the parameter of the assembly at at least one of the following: several points of time and several measuring points;
an analyzer configured to group the values of the parameter in several groups and determine a number of the values in a group; and
a warning device configured to trigger a signal if the number of values of at least one group is not congruent with a predetermined range of numbers.

12. The detector device according to claim 11, wherein the parameter is at least one of the following
a physical parameter that is sampled by at least one sensor of the measuring device; and
an operating parameter of a controller of the assembly, the operating parameter being detected by a monitoring device.

13. The detector device according to claim 12, wherein the sensor is configured to measure at least one of the following
a temperature in the assembly;
a temperature on the assembly;
a speed of a propulsion unit of the flying object;
a voltage in the assembly; and
a voltage on the assembly.

14. The detector device according to claim 12, wherein the measuring device is configured to detect at least one of the following
a duration of a process of the controller;
a duration of memories utilized by the controller; and
data communication taking place in the controller.

15. The detector device according to claim 13, wherein the measuring device is configured to detect at least one of the following
a duration of a process of the controller;
a duration of memories utilized by the controller; and
data communication taking place in the controller.

16. The detector device according to claim 11, wherein
the analyzer is configured to set up a statistic from the detected values, the criterion for grouping of at least one group being different from the criterion of another group, and the criterion for grouping of at least one group is further preferably determined by a range of values related to an error of the assembly.

17. The detector device according to claim 16, wherein
the predetermined range of numbers is a predetermined statistic, and the warning device is configured to compare a set up statistic with the predetermined statistic.

18. The detector device according to claim 12, wherein
the analyzer is configured to set up a statistic from the detected values, the criterion for grouping of at least one group being different from the criterion of another group, and the criterion for grouping of at least one group is further preferably determined by a range of values related to an error of the assembly.

19. A flying object comprising
an assembly; and
a detector device configured to detect an error in an assembly according to claim 11.

20. A flying object comprising
an assembly; and
a detector device configured to detect an error in an assembly according to claim 12.
